(19) United States
(12) Patent Application Publication
(10) Pub. No.: US 2012/0166566 A1
(43) Pub. Date: Jun. 28, 2012

(54) ELECTRONIC EQUIPMENT, MAIL RECORDING METHOD AND COMPUTER-READABLE STORAGE MEDIUM

(75) Inventor: Katsuaki AKAMA, Kawasaki (JP)

(73) Assignee: FUJITSU LIMITED, Kawasaki-shi (JP)

(21) Appl. No.: 13/410,886

(22) Filed: Mar. 2, 2012

Related U.S. Application Data
(63) Continuation of application No. PCT/JP2009/065536, filed on Sep. 4, 2009.

(51) Int. Cl. G06F 15/16

(52) U.S. Cl. 709/206

(57) ABSTRACT

An electronic equipment sends a mail specifying destinations, confirms mail delivery to the destinations based on a delivery confirmation notification received for the mail with respect to the destinations, records in a first storage the sent mail whose delivery is being confirmed together with each destination for which the delivery is being confirmed, records in a second storage the mail whose delivery is confirmed together with each destination for which the delivery is confirmed, and copies the mail from the first to the second storage when the notification is first received and moves each destination for which the notification is received to the second storage.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP/2009/065536 filed on Sep. 4, 2009, in the Japanese Patent Office, the disclosure of which is hereby incorporated by reference.

### FIELD

The present invention generally relates to a mail recording function of an electronic equipment, such as a portable terminal equipment, having a multicast mail sending and receiving function, and more particularly to an electronic equipment, a mail recording method, and a computer-readable storage medium storing a mail recording program, that may improve a function to record and manage a multicast mail sent to a plurality of destinations, for example.

### BACKGROUND

A portable terminal equipment, such as a portable telephone, may include a multicast mail function to send a mail having the same text content with respect to a plurality of destinations, using a message communication system such as the SMS (Short Message Service).

For example, a Japanese Laid-Open Patent Publication No. 9-331349 proposes storing the text of the multicast mail that is received and sorting information thereof in a storage unit when a mail having contents identical to those of the received mail is not stored in the storage unit. The text of the stored mail may be delivered to the destination in response to a delivery request.

On the other hand, a Japanese Laid-Open Patent Publication No. 2002-290619 proposes generating a list of destinations to which the mail delivery failed when a notification is received indicating the destinations to which the mail delivery failed.

The purpose of automatically registering and managing a group of destinations to which the mail delivery failed is to reduce the settings that are required when resending the mail to the undelivered destinations. When resending the mail, the group of destinations to which the mail delivery failed may be specified, and the destination to which the undelivered mail is to be resent may be set, for example, in order to reduce the settings that are required.

When the mail is managed in the above described manner and a new mail is sent by editing the mail recorded in the list of sent mail, the delivery of the new mail to the destination may fail when this destination belongs to the group of destinations to which the mail delivery failed. In this case, the destination of the new mail is also registered in the group of destinations to which the mail delivery failed. For this reason, when resending the new mail, the group of destinations to which the mail delivery failed need to be specified again, and the destination to which the undelivered new mail is to be resent needs to be set again. Consequently, a troublesome operation is required to resend the new mail to the undelivered destination.

### SUMMARY

Accordingly, one object according to one aspect of the embodiment is to provide an electronic equipment, a mail recording method, and a non-transitory computer-readable storage medium, that may facilitate confirmation of a mail and a destination thereof after the mail is delivered, and improve reusability of the mail.

Another object according to one aspect of the embodiment is to provide an electronic equipment, a mail recording method, and a non-transitory computer-readable storage medium, that improve a function of recording of a mail before or after confirming delivery of the mail.

According to one aspect of the present invention, an electronic equipment may include a processor, wherein the processor includes a mail sending part configured to send a mail specifying a plurality of destinations; a delivery confirming part configured to confirm delivery of the mail to the plurality of destinations based on a delivery confirmation notification received for the mail with respect to the plurality of destinations; a delivery confirming recording part configured to record the mail sent by the mail sending part and whose delivery is being confirmed by the delivery confirming part together with each destination for which the delivery is being confirmed; a delivery confirmed recording part configured to record the mail whose delivery is confirmed by the delivery confirming part together with each destination for which the delivery is confirmed; and a recording control part configured to copy the mail from the delivery confirming recording part to the delivery confirmed recording part when the delivery confirmation notification is first received by the delivery confirming part, and move each destination for which the delivery confirmation notification is received from the delivery confirming recording part to the delivery confirmed recording part.

According to another aspect of the present invention, a mail recording method to be implemented in an electronic equipment may have a processor that is caused to perform a process including sending a mail specifying a plurality of destinations; confirming delivery of the mail to the plurality of destinations based on a delivery confirmation notification received for the mail with respect to the plurality of destinations; recording, in a delivery confirming recording part, the mail sent by the sending and whose delivery is being confirmed by the confirming together with each destination for which the delivery is being confirmed; recording, in a delivery confirmed recording part, the mail whose delivery is confirmed by the confirming together with each destination for which the delivery is confirmed; and controlling recording in order to copy the mail from the delivery confirming recording part to the delivery confirmed recording part when the delivery confirmation notification is first received by the confirming, and move each destination for which the delivery confirmation notification is received from the delivery confirming recording part to the delivery confirmed recording part.

According to still another aspect of the present invention, a non-transitory computer-readable storage medium storing a program which, when executed by a computer, may cause the computer to perform a process including a mail sending procedure to send a mail specifying a plurality of destinations; a delivery confirming procedure to confirm delivery of the mail to the plurality of destinations based on a delivery confirmation notification received for the mail with respect to the plurality of destinations; a delivery confirming procedure to record, in a delivery confirming recording part, the mail sent by the mail sending procedure and whose delivery is being confirmed by the delivery confirming procedure together with each destination for which the delivery is being confirmed; a delivery confirmed recording procedure to record, in a delivery confirmed recording part, the mail whose delivery is confirmed by the delivery confirming procedure together with each destination for which the delivery is confirmed; and a recording control procedure to copy the mail from the delivery confirming recording part to the delivery confirmed recording part when the delivery confirmation notification is first received by the delivery confirming procedure, and move each destination for which the delivery confirmation notification is received from the delivery confirming recording part to the delivery confirmed recording part.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of an electronic equipment in a first embodiment;

FIG. 2 is a flow chart for explaining an example of procedures of a mail recording process in the first embodiment;

FIG. 3 is a flow chart for explaining an example of the procedures of the mail recording process in a modification of the first embodiment;

FIG. 4 is a block diagram illustrating an example of a portable telephone in a second embodiment;

FIG. 5 is a block diagram illustrating the portable telephone during a delivery confirmation;

FIG. 6 is a block diagram illustrating the portable telephone during the delivery confirmation;

FIG. 7 is a block diagram illustrating the portable telephone during the delivery confirmation;

FIG. 8 is a block diagram illustrating an example of functional parts of the portable telephone;

FIG. 9 is a block diagram illustrating an example of a hardware of the portable telephone;

FIG. 10 is a diagram illustrating an example of a structure of the portable telephone;

FIG. 11 is a block diagram illustrating an example of functional parts of a SMS center;

FIG. 12 is a block diagram illustrating an example of a hardware of the SMS center;

FIG. 13 is a flow chart for explaining an example of procedures of a mail recording process;

FIG. 14 is a flow chart for explaining the example of the procedures of the mail recording process;

FIG. 15 is a flow chart for explaining an example of the procedures of the mail recording process in a modification;

FIG. 16 is a diagram illustrating an example of processing contents of the mail recording process;

FIG. 17 is a diagram illustrating an example of a display screen of the portable telephone;

FIG. 18 is a flow chart for explaining an example of procedures of a mail recording confirmation process in a third embodiment;

FIG. 19 is a block diagram for explaining a mail sending process of a portable telephone in a comparison example;

FIG. 20 is a diagram illustrating an example of a PDA (Personal Digital Assistant) in another embodiment; and

FIG. 21 is a diagram illustrating a PC (Personal Computer) in another embodiment.

### DESCRIPTION OF EMBODIMENTS

Preferred embodiments of the present invention will be described with reference to the accompanying drawings.

### First Embodiment

In a first embodiment, an electronic equipment includes a mail sending function and a mail recording function. The mail sending function includes a function to send a multicast mail to a plurality of destinations, and the mail recording function includes a function to record the multicast mail and the destinations thereof. The mail recording function may be realized by a delivery confirming recording part and a delivery confirmed recording part. The delivering confirming recording part records the mail whose delivery is being confirmed and destination information of this mail. After the delivery of the mail is first confirmed, this mail is copied from the delivery confirming recording part to the delivery confirmed recording part. In addition, the destination information of the mail whose delivery is confirmed is moved from the delivery confirming recording part to the delivery confirmed recording part. The mail that is sent and the destination to which the delivery is being confirmed may be confirmed from the recorded contents of the delivery confirming recording part, and the delivered mail and the delivered destination may be recognized from the recorded contents of the delivery confirmed recording part. Hence, the mail whose delivery is being confirmed, the destination to which the delivery is being confirmed, the delivered mail, and the destination of the delivered mail may be confirmed from the different recording parts, in order to improve the reusability of the mail, including the destination of the delivered mail, editing of the delivered mail, and the like.

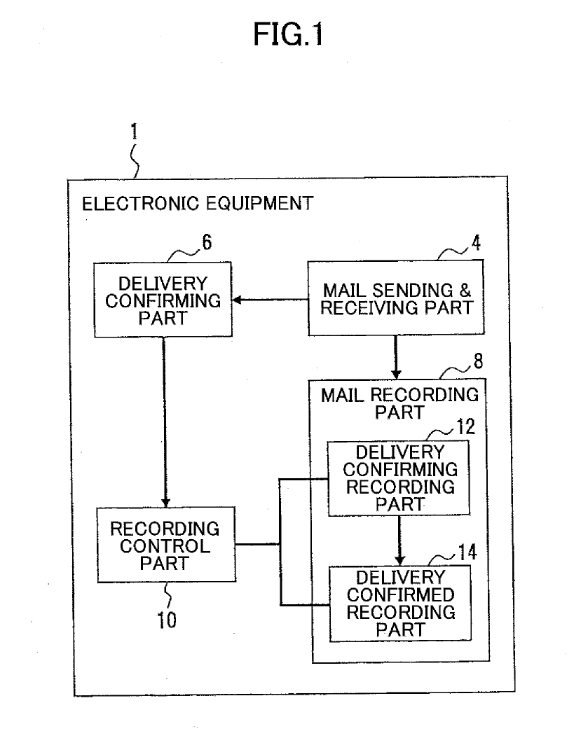

Next, a description will be given of this first embodiment, by referring to FIG. 1. FIG. 1 is a block diagram illustrating an example of an electronic equipment in this first embodiment. A structure illustrated in FIG. 1 is merely an example, and the present invention is of course not limited to such a structure.

An electronic equipment 1 is an example of an electronic mail apparatus including the function of sending the multicast mail to a plurality of destinations. The electronic equipment 1 includes a mail sending and receiving part 4, a delivery confirming part 6, a mail recording part 8, and a recording control part 10.

The mail sending and receiving part 4 is an example of a functional part configured to send a common multicast mail with respect to a plurality of destinations. In this case, the plurality of destinations are the destinations to which the common multicast mail is to be sent. In addition, the common multicast mail includes mails at least having the same mail text (or body of mail that is the same).

The delivery confirming part 6 is an example of a functional part configured to receive a delivery confirmation notification indicating the delivery of the sent mail, and confirm the mail delivery. The delivery confirmation notification is made for each of the destinations of the mail, and the delivered mail and the destinations thereof may be recognized from the delivery confirmation notification.

The mail recording part 8 is an example of a functional part configured to record the mail, and may be formed by a suitable computer-readable recording medium. The mail recording part 8 includes a delivering confirming recording part 12 and a delivery confirmed recording part 14.

The recording control part 10 is an example of a functional part configured to execute a recording control including recording the mail and the destination information with respect to the delivery confirming recording part 12, copying the mail from the delivery confirming recording part 12 to the delivery confirmed recording part 14, moving the destination information from the delivery confirming recording part 12 to the delivery confirmed recording part 14, and the like.

The delivery confirming recording part 12 is an example of a functional part configured to record, together with mail information indicating the sent mail, the destination information indicating the destinations of the sent mail. The delivery confirming recording part 12 records the mail whose delivery is being confirmed and the destinations of this mail. In other words, the mail whose delivery is being confirmed, and the destinations of this mail whose delivery is being confirmed may be confirmed from the recorded contents of the delivery confirming recording part 12.

The delivery confirmed recording part 14 is an example of a functional part configured to record the mail after confirming the first delivery thereof, and the destination information indicating the destinations of the mail whose delivery is confirmed. The delivery confirmed recording part 14 records, together with one mail whose delivery is confirmed, the destination information indicating the plurality of destinations of this one mail whose delivery is confirmed.

When the mail is sent to the plurality of destinations, this mail and the destination information of the plurality of destinations are recorded in the mail recording part 8 by the delivery confirming recording part 12. When the delivery confirming part 6 confirms the first delivery of the mail after the mail is sent, the mail whose delivery is confirmed is copied from the delivery confirming recording part 12 to the delivery confirmed recording part 14 in response to this delivery confirmation. In addition, the destination information is moved from the delivery confirming recording part 12 to the delivery confirmed recording part 14 for every delivery confirmation. Accordingly, the mail whose delivery is being confirmed and the destination information of this mail are recorded in the delivery confirming recording part 12, and the mail whose delivery is confirmed and the destination information of this main are recorded in the delivery confirmed recording part 14. The destination information after the delivery confirmation is erased from the delivery confirming recording part 12 by being moved to the delivery confirmed recording part 14, and may only be confirmed from the delivery confirmed recording part 14.

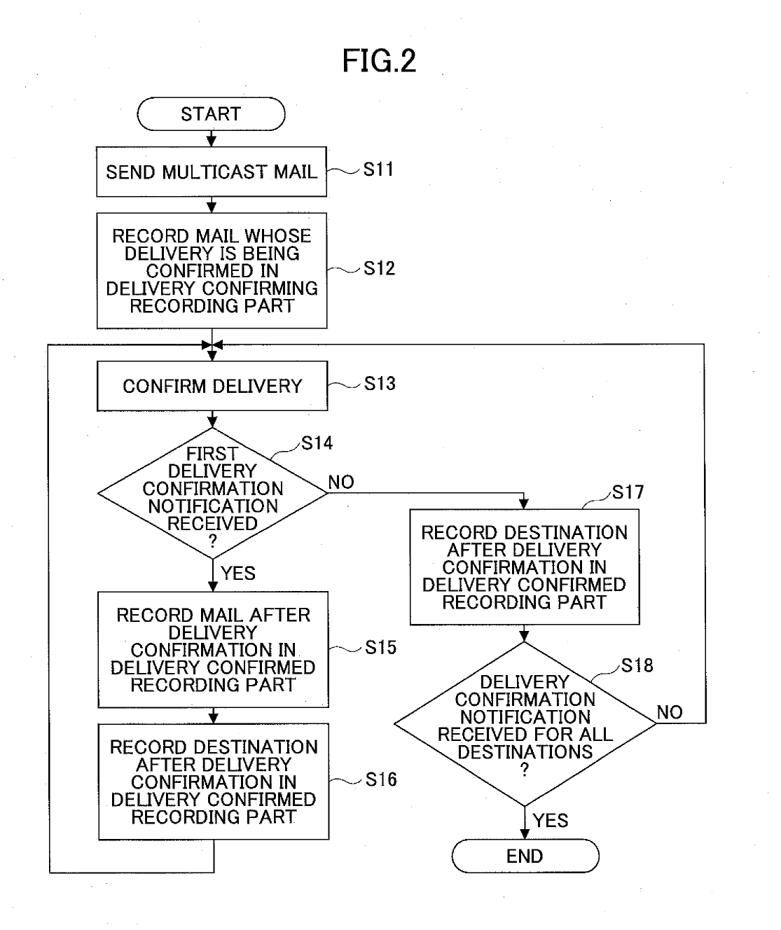

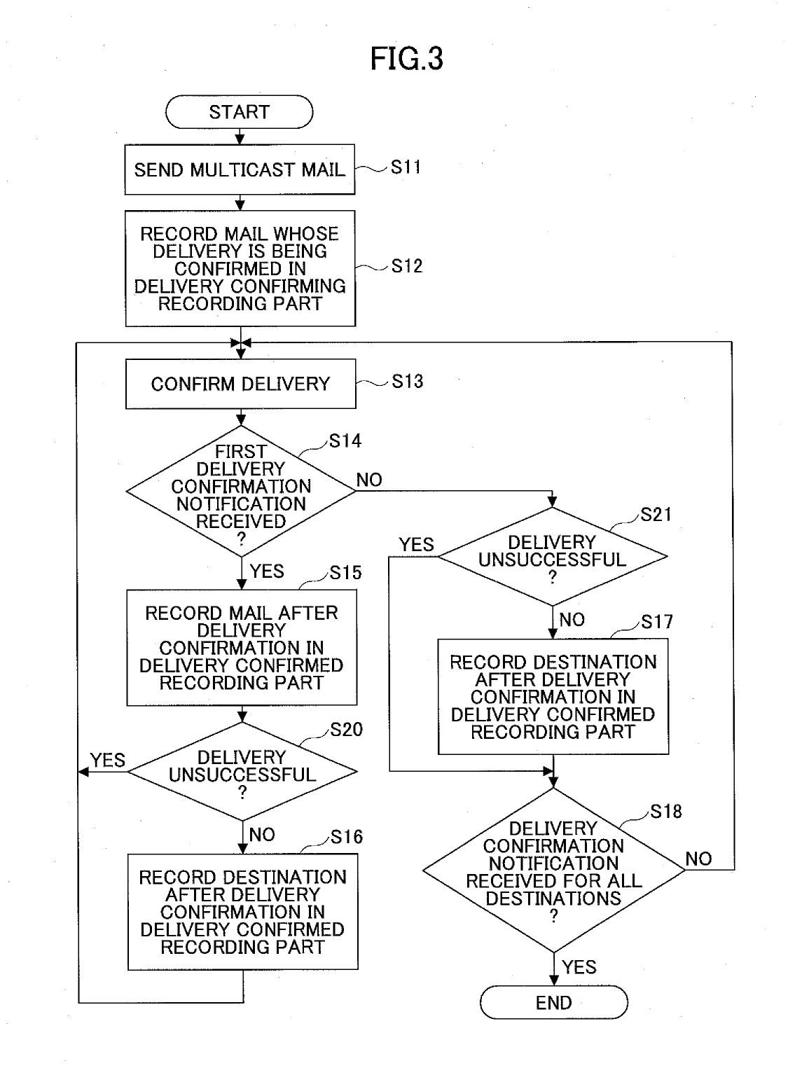

Next, a description will be given of a mail recording process (or function), by referring to FIGS. 2 and 3. FIG. 2 is a flow chart for explaining an example of procedures of the mail recording process in the first embodiment, and FIG. 3 is a flow chart for explaining an example of the procedures of the mail recording process in a modification of the first embodiment. The procedures of the process illustrated in FIGS. 2 and 3 are merely examples, and the present invention is not limited to such procedures.

The mail recording process is an example of the disclosed mail recording method or mail recording program to be implemented in the electronic equipment 1 having the function of sending the multicast mail to the plurality of destinations. The mail recording program may be stored in a non-transitory computer-readable storage medium. The mail recording program, when executed by a computer, may cause the computer to perform the mail recording process. In other words, the mail recording program, when executed by the computer, may cause the computer to function as the electronic equipment 1 in which the mail recording method is implemented.

In the mail recording process illustrated in FIG. 2, when the multicast mail is sent in a step S11, this mail whose delivery is being confirmed is recorded in the delivery confirming recording part 12 in a step S12, in order to control the electronic equipment 1 to a standby state.

In the standby state, the delivery of the mail is confirmed in a step S13. When confirming the delivery of the mail, a decision is made in a step S14 to determine whether the delivery confirmation notification indicating the delivery of the sent mail is received for the first time. The delivery confirmation notification includes delivery complete information indicating that the mail is successfully delivered to the destination or, undelivered information indicating that the delivery of the mail is unsuccessful (or failed). Hence, when confirming the delivery of the mail, a judgement is made to determine whether the delivery confirmation notification includes the delivery complete information or the undelivered information.

When the delivery confirmation notification indicating the delivery of the sent mail is received and this delivery confirmation notification is received for the first time and the decision result in the step S14 is YES, the mail after the delivery confirmation is copied to the delivery confirmed recording part 14 in a step S15. In other words, the mail after the delivery confirmation is recorded in the delivery confirmed recording part 14. In addition, when the delivery confirmation notification includes the delivery complete information, the destination information after the delivery confirmation is moved to the delivery confirmed recording part 14 in a step S16, and the process returns to the step S13. In other words, the destination information after the delivery confirmation is also recorded in the delivery confirmed recording part 14.

When the delivery confirmation notification indicating the delivery of the sent mail is received and this delivery confirmation notification is not received for the first time and the decision result in the step S14 is NO, the process advances to a step S17. When the delivery confirmation notification includes the delivery complete information, the destination information of the destination to which the delivery of the mail is confirmed is moved to the delivery confirmed recording part 14 in the step S17. In other words, the destination information of the destination to which the delivery of the mail is confirmed is recorded in the delivery confirmed recording part 14.

With respect to all of the destinations of the mail that is sent, a decision is made in a step S18 to determine whether the delivery confirmation notification indicating the delivery of the sent mail is received. The process of the steps S13 through S18 is executed until the delivery confirmation notification is received for all of the destinations. When the delivery confirmation notification is received for all of the destinations and the decision result in the step S18 is YES, the mail recording process ends.

The mail recording process may include a function of judging unsuccessful delivery of the mail and moving the destination information depending on the judgement result. In this case, when the delivery of the mail is confirmed for the first time, a decision may be made in a step S20 illustrated in FIG. 3 to determine whether the delivery of the mail to the destination is unsuccessful, before recording the destination information in the delivery confirmed recording part 14. When the delivery of the mail to the destination is successful and the decision result in the step S20 is NO, the destination information of the successfully delivered mail is recorded in the delivery confirmed recording part 14 in the step S16.

On the other hand, when the delivery of the mail is confirmed not for the first time, a decision may be made in a step S21 illustrated in FIG. 3 to determine whether the delivery of the mail to the destination is unsuccessful, before recording the destination information in the delivery confirmed recording part 14. When the delivery of the mail to the destination is successful and the decision result in the step S21 is NO, the destination information of the successfully delivered mail is recorded in the delivery confirmed recording part 14 in the step S17.

According to this modification, the destination information of the unsuccessfully delivered mail remains in the delivery confirming recording part 12 and will not be moved to the delivery confirmed recording part 14. Hence, with respect to all of the destinations, it is possible to recognize whether the delivery of the mail to a specific destination is unsuccessful after receiving the delivery confirmation notification.

### Second Embodiment

In a second embodiment, a portable telephone (or mobile telephone) is an example of an electronic equipment that includes a mail sending function and a mail recording function. When a plurality of destinations are specified for a mail in the portable telephone, the mail is recorded in a delivery confirming recording part until the delivery of the mail is confirmed. When the delivery confirmation notification is received for the first time, the mail in the delivery confirming recording part is copied to a delivery confirmed recording part. In addition, destination information of only the destinations to which the delivery of the mail is confirmed is moved from the delivery confirming recording part to the delivery confirmed recording part. Hence, only the destination information of the destinations to which the delivery of the mail is confirmed is recorded with respect to the mail in the delivery confirming recording part, and the mail whose delivery is confirmed may be edited and reused.

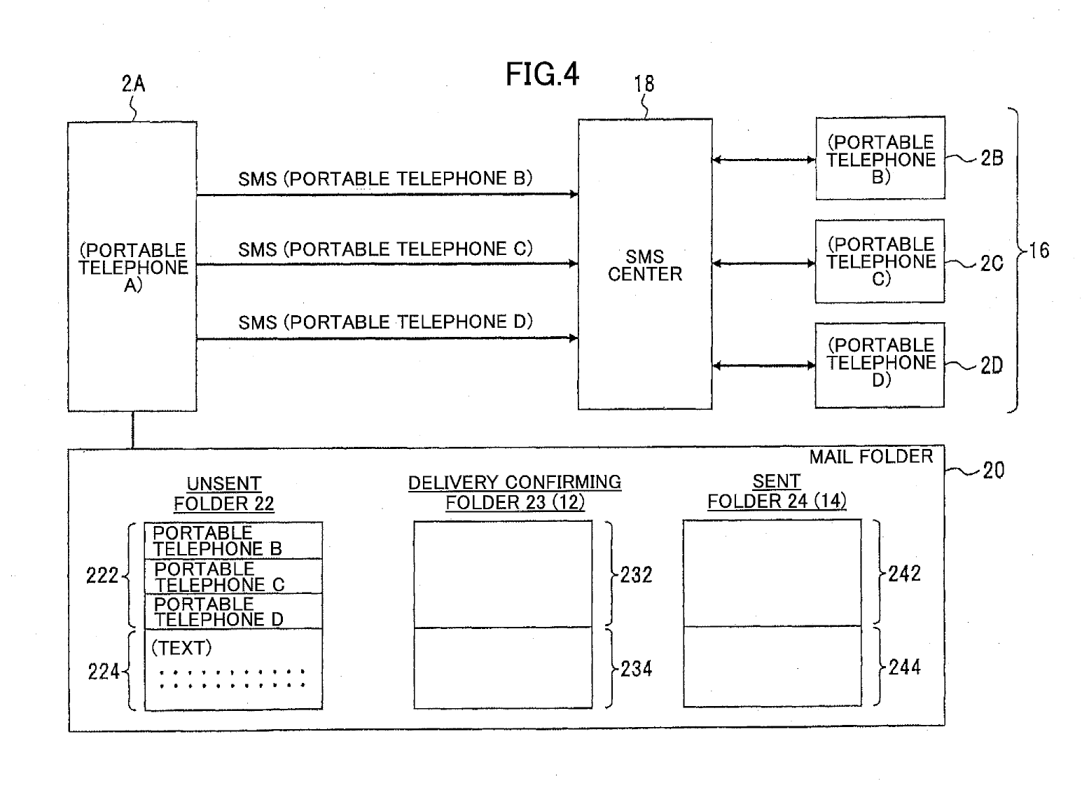

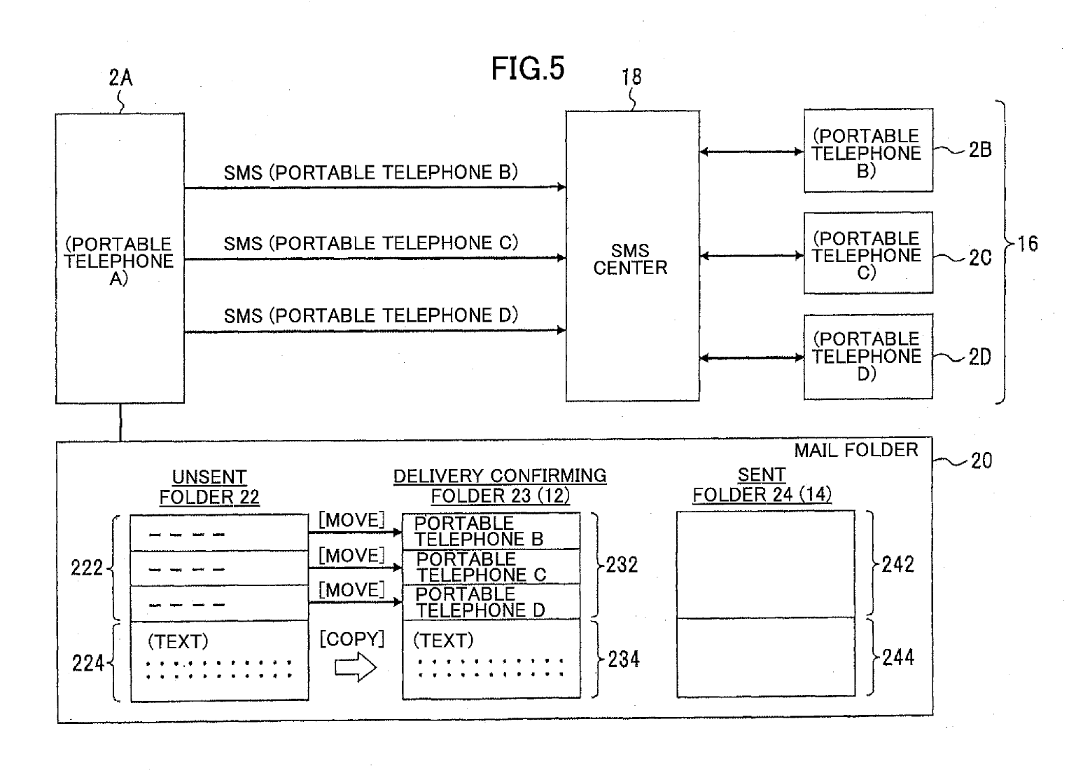

A description will be given of this second embodiment, by referring to FIGS. 4 through 7. FIG. 4 is a block diagram illustrating an example of the portable telephone in this second embodiment. FIGS. 5 through 7 are block diagrams illustrating the portable telephone during a delivery confirmation. A structure illustrated in FIGS. 4 through 7 is merely an example, and the present invention is of course not limited to such a structure.

A portable telephone 2A is an example of the disclosed electronic equipment. An electronic mail function of the portable telephone 2A includes a mail sending and receiving function, such as a message communication function (for example, SMS (Short Mail Service)).

In this example, the portable telephone 2A sends a multicast mail to a plurality of destinations 16, such as portable telephones 2B, 2C, and 2D, as illustrated in FIG. 4. The multicast mail includes mails at least having the same (or common) mail text, and is sent to the plurality of destinations 16. The same mail text is not limited to sentences, and the multicast mail may be sent by SMS. The multicast mail is sent via a SMS center 18. The SMS center 18 is an example of a mail relay apparatus provided in a base station. The SMS center 18 includes a functional part configured to confirm the delivery of the multicast mail to the portable telephones 2B, 2C, and 2D at the destinations, and return the delivery confirmation notification to the portable telephone 2A.

A mail folder 20, corresponding to the mail recording part 8 illustrated in FIG. 1, is provided in the portable telephone 2A. This mail folder 20 includes an unsent folder 22, a delivery confirming folder 23, and a sent folder 24. The unsent folder 22 is an example of a predelivery recording part configured to store the destination information and the mail text of the mail to be sent, that is, before the mail is sent. A destination information storing part 222, and a mail text storing part 224 are provided in the unsent folder 22. The destination information storing part 222 stores “portable telephone B”, “portable telephone C”, and “portable telephone D” indicating the portable telephones 2B, 2C, and 2D, as the destination information. The mail text storing part 224 stores the mail text of the multicast mail that is being sent to the destinations.

The delivery confirming folder 23 is an example of the above described delivery confirming recording part 12 configured to record the mail whose delivery is being confirmed. A destination information storing part 232, and a mail text storing part 234 are provided in the delivery confirming folder 23. As illustrated in FIG. 5, the destination information storing part 232 stores the destination information indicating the portable telephones 2B, 2C, and 2D. The mail text storing part 234 stores the mail text of the multicast mail that is being sent to the destinations.

The sent folder 24 is an example of the delivery confirmed recording part 14 described above. A destination information storing part 242, and a mail text storing part 244 are provided in the sent folder 24. The destination information storing part 242 provides a storage area for storing the destination information, and the mail text storing part 244 provides a storage area for storing the mail text.

A sent mail recording function includes the following.

(1) Before Sending Multicast Mail (FIG. 4):

When sending the multicast mail from the portable telephone 2A to the portable telephones 2B, 2C, and 2D, the destination information and the mail text are recorded in the unsent folder 22 as illustrated in FIG. 4 before sending the multicast mail. In this case, the “portable telephone B”, “portable telephone C”, and “portable telephone D” are stored in the destination information storing part 222 as the destination information. In addition, the mail text of the multicast mail is stored in the mail text storing part 224. The portable telephone 2A is maintained in a standby state.

(2) Immediately After Sending Multicast Mail (FIG. 5):

Immediately after the multicast mail is sent from the portable telephone 2A to the portable telephones 2B, 2C, and 2D, the destination information and the mail text are recorded in the delivery confirming folder 23, as illustrated in FIG. 5. In this case, the “portable telephone B”, “portable telephone C”, and “portable telephone D” are stored in the destination information storing part 232 as the destination information. In addition, the mail text of the multicast mail is stored in the mail text storing part 234. The portable telephone 2A is maintained in the standby state.

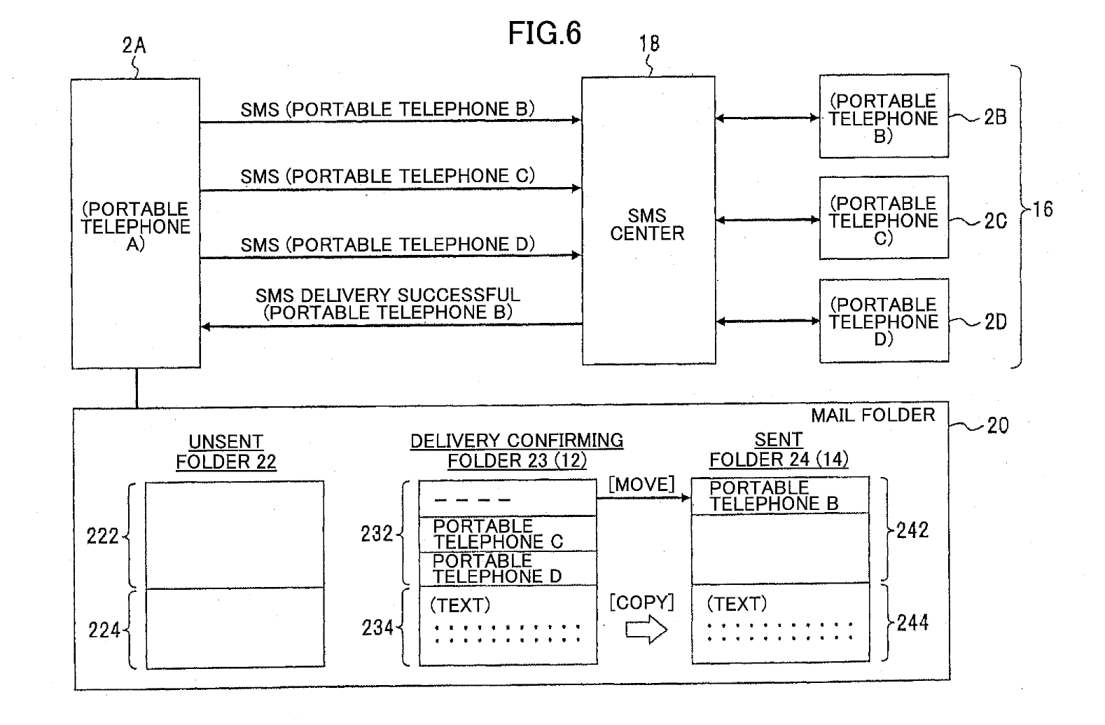

(3) Receiving Delivery Confirmation (For First Delivery, FIG. 6):

After the multicast mail is sent, the SMS center 18 sends “SMS delivery successful (portable telephone B)” as the delivery confirmation notification of the portable telephone 2B as illustrated in FIG. 6, for example. When the portable telephone 2A receives the delivery confirmation notification from the SMS center 18, the portable telephone 2A copies the mail text of the multicast mail from the mail text storing part 234 of the delivery confirming folder 23 to the mail text storing part 244 of the sent folder 24 in response to this delivery confirmation notification. At the same time, the destination information “portable telephone B” indicating the portable telephone 2B is moved from the destination information storing part 232 to the destination information storing part 242. As a result, the delivered mail text may be confirmed from the sent folder 24, and it is possible to recognize therefrom that the destination of the successful delivery is the “portable telephone B”.

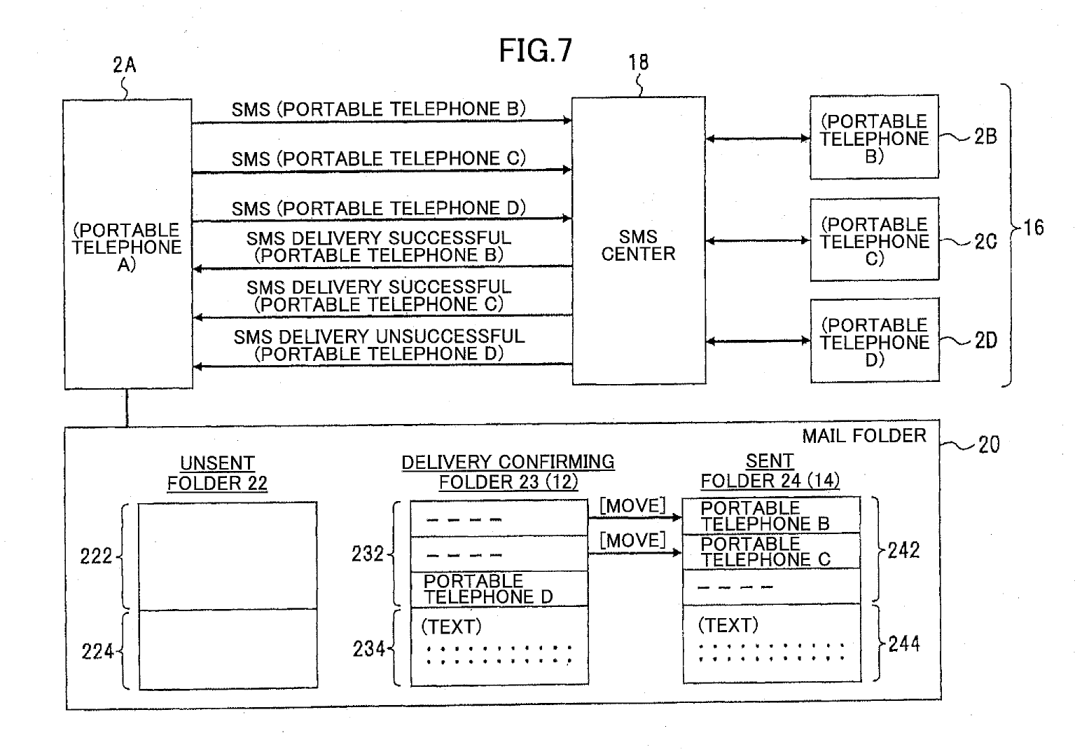

(4) Receiving Delivery Confirmation (For All Destinations, FIG. 7):

After the first delivery of the multicast mail is confirmed, the delivery results from all of the remaining destinations are received by the portable telephone 2A as illustrated in FIG. 7. For example, a delivery confirmation notification “SMS delivery successful (portable telephone C)”, and an undelivered confirmation notification “SMS delivery unsuccessful (portable telephone D)” are received. In this case, the portable telephone 2A moves the destination information in response to each confirmation notification. In other words, the portable telephone 2A moves the destination information “portable telephone C” indicating the portable telephone 2C, corresponding to the mail text of the multicast mail, to the destination information storing part 242 of the sent folder 24 in response to the delivery confirmation notification “SMS delivery successful (portable telephone C)”. In addition, the portable telephone 2A records the destination information “portable telephone D” together with the mail text whose delivery is being confirmed to the delivery confirming folder 23, in response to the undelivered confirmation notification “SMS delivery unsuccessful (portable telephone D)”. Hence, it is possible to recognize from the recorded contents of the sent folder 24 the successfully delivered mail text and the destinations “portable telephone B” and “portable telephone C” of the successfully delivered mail text. Further, it is possible to recognize from the recorded contents of the delivery confirming folder 23 the unsuccessfully delivered mail text and the destination “portable telephone D” of the unsuccessfully delivered mail text, when the undelivered confirmation notification “SMS delivery unsuccessful (portable telephone D)” is received from the SMS center 18.

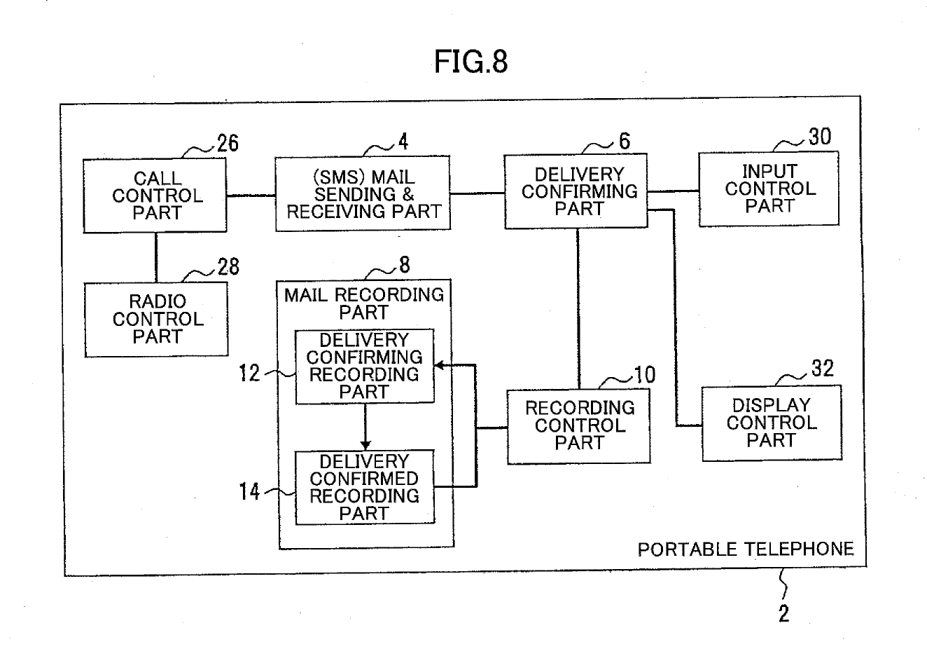

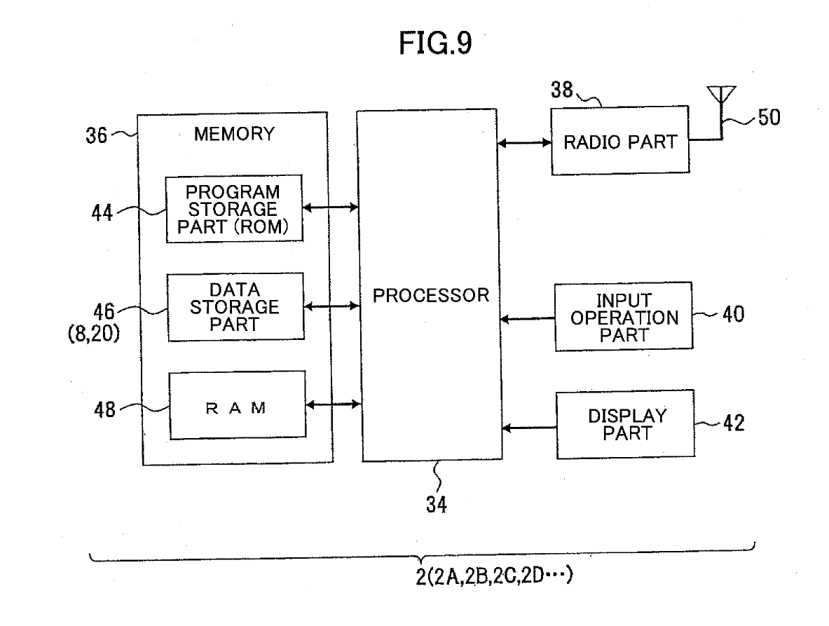

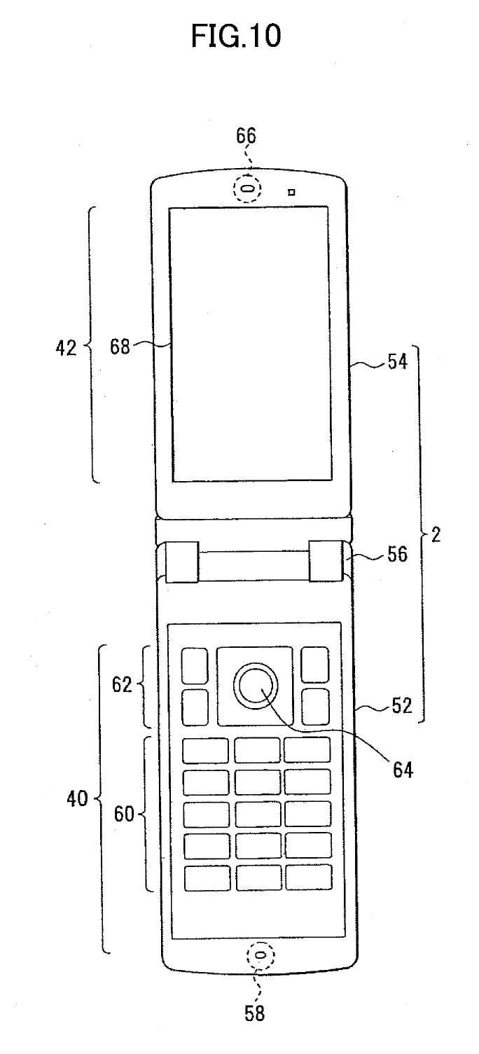

Next, a description will be given of the portable telephone, by referring to FIGS. 8 through 10. FIG. 8 is a block diagram illustrating an example of functional parts of the portable telephone, FIG. 9 is a block diagram illustrating an example of a hardware of the portable telephone, and FIG. 10 is a diagram illustrating an example of a structure of the portable telephone. Structures illustrated in FIGS. 8 through 10 are merely examples, and the present invention is of course not limited to such structures. In FIGS. 8 through 10, those parts that are the same as those corresponding parts in FIG. 1 are designated by the same reference numerals.

A portable telephone 2 is an example of an electronic equipment including a mail sending and receiving function and configured to send a multicast mail to a plurality of destinations. The portable telephone 2 may form each of the portable telephones 2A, 2B, 2C, and 2D described above in conjunction with FIGS. 4 through 7. As illustrated in FIG. 8, the portable telephone 2 includes a mail sending and receiving part 4, a delivery confirming part 6, a mail recording part 8, a recording control part 10, a call control part 26, a radio control part 28, an input control part 30, and a display control part 32.

The mail sending and receiving part 4 is an example of a functional part configured to send and receive a SMS (Short Message Service) mail. The delivery confirming part 6, the mail recording part 8, and the recording control part 10 are as described above in conjunction with FIG. 1.

The call control part 26 is an example of a functional part configured to control calling or receiving a call. The call control part 25 controls receiving the call or making the call, via the radio control part 28, and makes a telephone connection with respect to a telephone number of a of the other party in communication via the base station. The radio control part 28 is an example of a functional part configured to control sending and receiving of communication signals.

The input control part 30 is an example of a functional part configured to control input, such as key inputs, to the portable telephone 2. The display control part 32 is an example of a functional part configured to control display on a display part.

The portable telephone 2 having the functions described above may be formed by a computer illustrated in FIG. 9. The computer illustrated in FIG. 9 includes a processor 34, a memory 36, a radio part 38, an input operation part 40, and a display part 42. The processor 34 may be formed by a CPU (Central Processing Unit) or the like, and may execute a program stored in the memory 36.

The memory 36 includes a program storage part 44, a data storage part 46, and a RAM (Random Access Memory) 48, and may be formed by a computer-readable storage medium. A magnetic disk, a flexible disk, a hard disk, optical disks (CD-ROM, CD-R, DVD, etc.), and magneto-optic disks (MD, etc.) may be used for the memory 36.

The program storage part 44 may store an OS (Operating System), middle software (or middleware), application programs, and the like. The disclosed mail recording program may be stored in the program storage part 44.

The data storage part 46 is an example of a storage part configured to store various data, various information, and the like. The mail recording part 8 illustrated in FIGS. 1 and 8, the mail folder 20 illustrated in FIGS. 4 through 6, and the like may be provided in the data storage part 46. Programs may be extracted to the RAM 48, and the RAM 48 may form a work area.

The radio part 38 is connected to an antenna 50 and is controlled by the processor 34. The radio part 38 is an example of a communication part configured to make a radio communication with the base station or a relay station such as the SMS center 18. Communication functions of the radio part 38 may include information communication, such as sending and receiving the multicast mail and receiving the delivery confirmation notification of the mail, demodulating and reproducing an audio signal from a received signal, generating a radio signal using the audio signal and a carrier signal, and the like.

The input operation part 40 is an example of an input part formed by a key input part or a touchscreen panel. Input information that is input from the input operation part 40 is controlled by the input control part 30 illustrated in FIG. 8. The input operation part 40 may be provided on a display screen of the display part 42 when the input operation part 40 is formed by the touchscreen panel.

The display part 42 is an example of a display configured to display character information, image information, and the like. For example, the display part 42 may be formed by display elements of a LCD (Liquid Crystal Display) or the like. The display part 42 is controlled by the processor 34, and the display control part 32 illustrated in FIG. 8 controls the display on the display part 42.

As illustrated in FIG. 10, the hardware of the portable telephone 2 includes a fixed casing (or housing) 52 that forms a first casing, a movable casing (or housing) 54 that forms a second casing, and a hinge part 56 joining the casings 52 and 54. The movable casing 54 may open and close with respect to the fixed casing 52 via the hinge part 56. The input operation part 40, a microphone 58, and the like are provided on the fixed casing 52. The input operation part 40 includes character keys 60, cursor keys 62, a submit key 64, and the like.

The display part 42, a receiver 66, and the like are provided on the movable casing 54. The display part 42 includes a display screen 68.

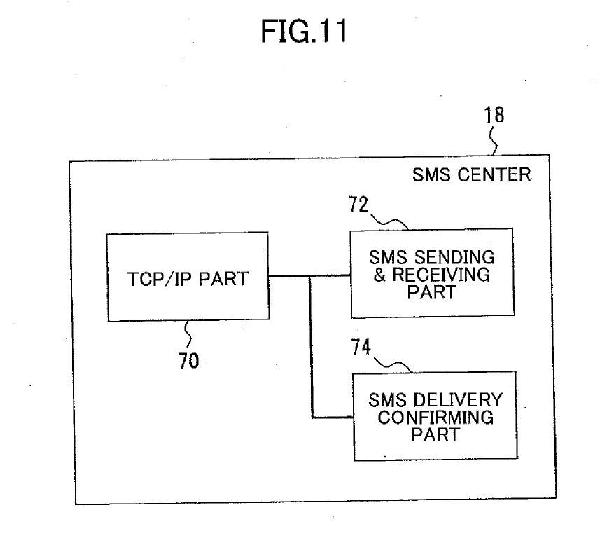

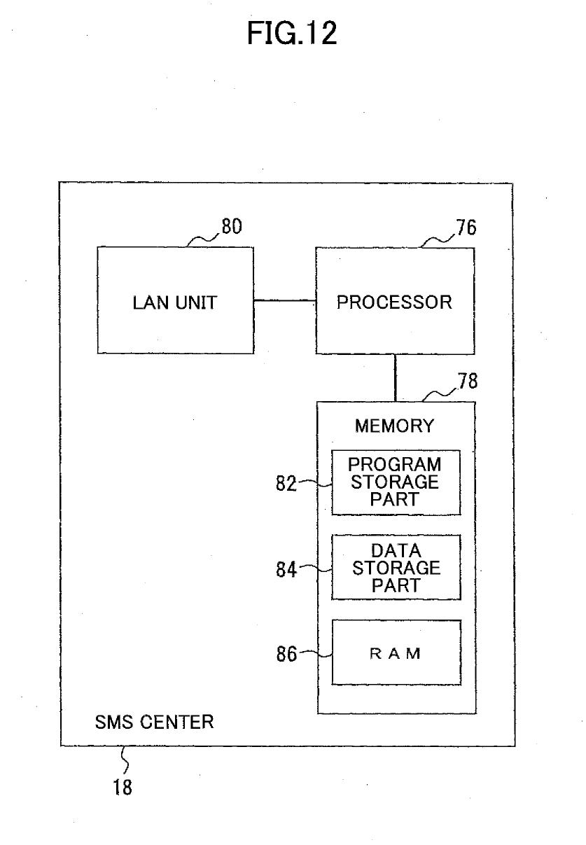

Next, a description will be given of the SMS center, by referring to FIGS. 11 and 12. FIG. 11 is a block diagram illustrating an example of functional parts of the SMS center, and FIG. 12 is a block diagram illustrating an example of a hardware of the SMS center. Structures illustrated in FIGS. 11 and 12 are merely examples, and the present invention is of course not limited to such structures.

The SMS center 18 is an example of a data relay part provided in the base station. As illustrated in FIG. 11, the SMS center 18 includes a TCP/IP (Transmission Control Protocol/Internet Protocol) part 70, a SMS sending and receiving part 72, and a SMS delivery confirming part 74.

The TCP/IP part 70 is an example of a functional part including a TCP part and an IP part. The TCP part is an example of a functional part configured to segment the data and create TCP packets in which an error correction data, a packet number, and the like are added to each of the data. The IP part is an example of a functional part configured to create IP packets in which a destination IP address and a sending source address are added to the TCP packets, and send the IP packets to a network. When the IP part of the TCP/IP part 70 receives the IP packet, the IP part supplies the packet to the TCP part. The TCP part checks whether an error exists in the packet, and restores the data from the packet when no error exists, and requests resending of the packet when an error exists.

The SMS sending and receiving part 72 is an example of a functional part configured to send and receive the multicast mail described above, and generate the delivery confirmation notification when the mail is delivered. In addition, the SMS delivery confirming part 74 is an example of a functional part configured to store the destination information of a plurality of mails, for example, and discriminate the destination from which a notification (or message) confirming the mail delivery is received upon receipt of such a notification.

The SMS center 18 having the functions described above may be formed by a computer illustrated in FIG. 12. The computer illustrated in FIG. 12 includes a processor 76, a memory 78, and a LAN (Local Area Network) unit 80. The processor 76 may be formed by a CPU (Central Processing Unit) or the like, and may execute a program stored in the memory 78.

The memory 78 includes a program storage part 82, a data storage part 84, and a RAM (Random Access Memory) 86, and may be formed by a computer-readable storage medium.

The program storage part 82 may store an OS (Operating System), middle software (or middleware), application programs, and the like. The disclosed mail recording program may be stored in the program storage part 82.

The data storage part 84 is an example of a storage part configured to store various data, various information, and the like, including destination information, date and time information and the like of the mail. Programs may be extracted to the RAM 86, and the RAM 86 may form a work area.

The LAN unit 80 may be formed by an information communication network linking computers, and is an example of a functional part configured to exchange information. The LAN unit 80 forms the TCP/IP part 70, the SMS sending and receiving part 72, and the SMS delivery confirming part 74, together with the processor 76.

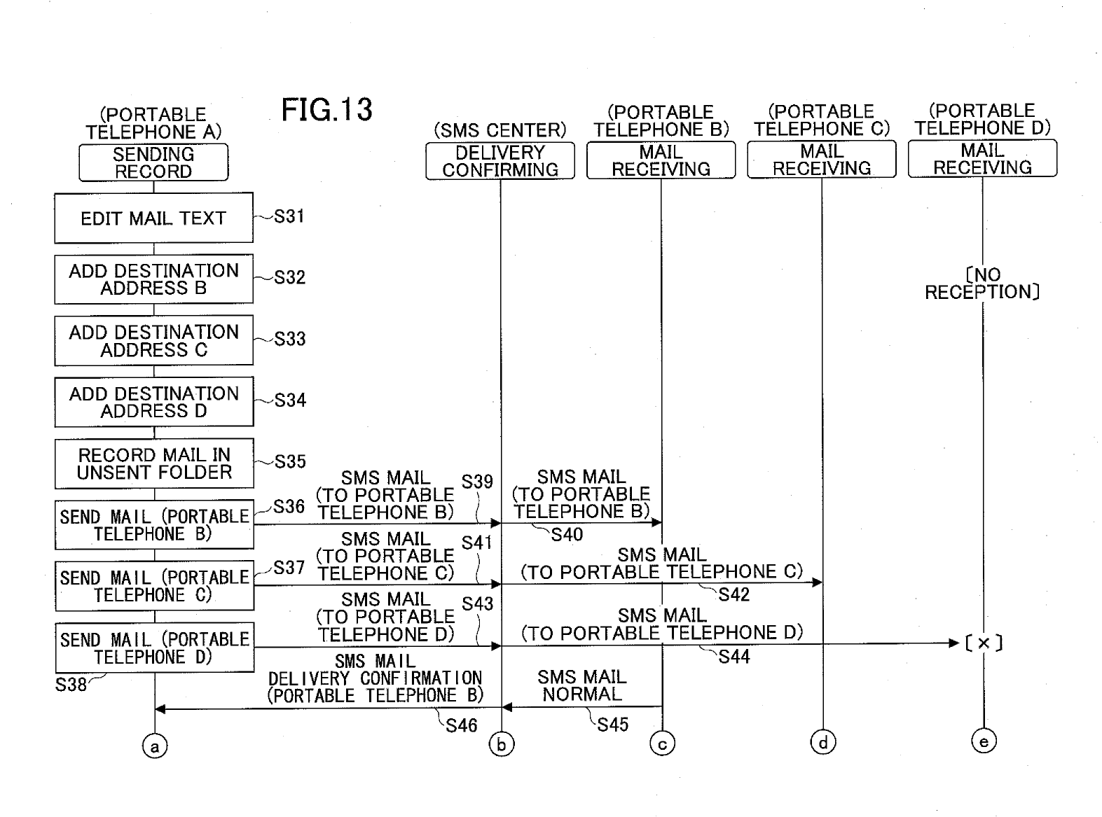

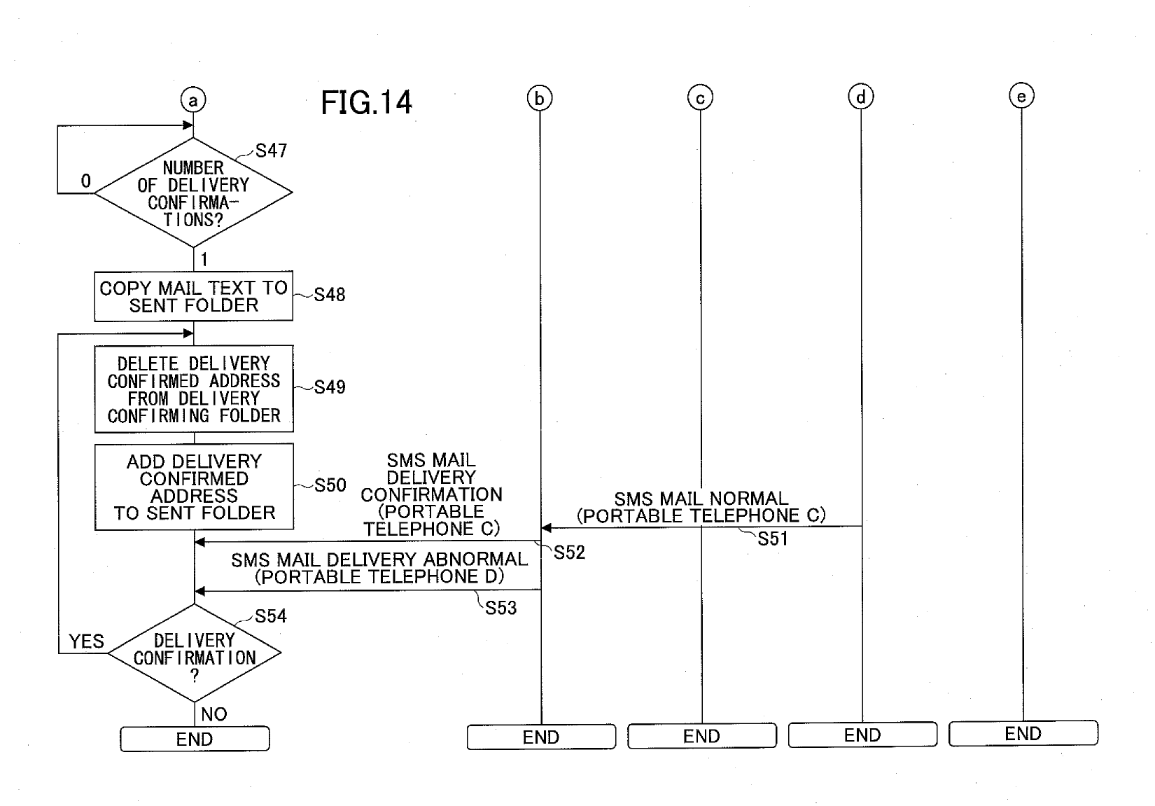

Next, a description will be given of the mail recording process, by referring to FIGS. 13 and 14. FIGS. 13 and 14 are flow charts for explaining an example of procedures of a mail recording process. Procedures of the mail recording process illustrated in FIGS. 13 and 14 are merely examples, and the present invention is of course not limited to such procedures. In FIGS. 13 and 14, “a”, “b”, “c”, “d”, and “e” are connectors linking the flow charts.

The mail recording process (or function) is an example of the disclosed mail recording method or the mail recording program. The mail recording process may include editing the mail text, sending the multicast mail, and recording the mail in the portable telephone 2A, confirming delivery of the mail in the SMS center 18, receiving mail in the portable telephones 2B and 2C, and unsuccessful delivery of the mail to the portable telephone 2D due to no reception. The portable telephone 2D is in a no reception state when the portable telephone 2D is out of a reception range.

As illustrated in FIG. 13, the portable telephone 2A edits the mail text in a step S31, and adds a destination address B (portable telephone B), a destination address C (portable telephone C), and a destination address D (portable telephone D) to the destination information storing part 222 of the unsent folder 22, as the plurality of destination addresses, in steps S32, S33, and S34, respectively. The portable telephone 2A records the mail text in the mail text recording part 224 in a step S35.

The sending of the mail is performed for each of the destinations in steps S36, S37, and S38, respectively. When the sending of the mail is started, the mail with respect to the destination address B (portable telephone B) is sent to the SMS center 18 in a step S39. The SMS center 18 that receives the mail with respect to the destination address B sends the mail to the destination B in a step S40. The portable telephone B receives the mail from the SMS center 18.

The mail with respect to the destination address C (portable telephone C) is sent to the SMS center 18 in a step S41. The SMS center 18 that receives the mail with respect to the destination address C sends the mail to the destination C in a step S42. The portable telephone C receives the mail from the SMS center 18.

The mail with respect to the destination address D (portable telephone D) is sent to the SMS center 18 in a step S43. The SMS center 18 that receives the mail with respect to the destination address D sends the mail to the destination D in a step S44. In this case, it is assumed for the sake of convenience that the portable telephone 2D is in the no reception state and the portable telephone 2D cannot receive the mail from the SMS center 18. Hence, the mail from the SMS center 18 is not delivered to the portable telephone 2D and the mail delivery thereto is unsuccessful as indicated by a symbol “[x]” in FIG. 13.

After the sending of the multicast mail is completed, a SMS mail normal message is sent from the portable telephone 2B to the SMS center 18 in a step S45. The SMS center 18 that receives the SMS mail normal message from the portable telephone 2B sends a SMS mail delivery confirmation related to the portable telephone 2B with respect to the portable telephone 2A in a step S46.

After the step S39, the mail text moves from the unsent folder 22 to the delivery confirming folder 23, and the destination information of the portable telephone B that is the first destination moves to the delivery confirming folder 23. In the subsequent steps S41 and S43, the destination information moves from the unsent folder 22 to the delivery confirming folder 23 every time the mail is sent, in order to advances to the delivery confirmation.

Hence, in the portable telephone 2A, the number of delivery confirmations is judged in a step S47 illustrated in FIG. 14, and the portable telephone 2A is in the standby state when the number of delivery confirmations is “0”. The first delivery confirmation stands when the number of delivery confirmations is “1”. After the first delivery confirmation, the mail text is copied to the sent folder 24 in a step S48. The delivery confirmed address of the destination is deleted from the delivery confirming folder 23 in a step S49, and the delivery confirmed address of the destination is added to the sent folder 24 in a step S50.

The delivery confirmation is continued to the end of the delivery confirmation, and the SMS mail normal message is sent from the portable telephone 2C with respect to the SMS center 18 in a step S51. The SMS center 18 that receives the SMS mail normal message from the portable telephone 2C sends a SMS mail delivery confirmation related to the portable telephone 2C with respect to the portable telephone 2A in a step S52.

In addition, because the mail sent with respect to the portable telephone 2D becomes an undelivered mail, the SMS center 18 sends a SMS mail delivery abnormal related to the portable telephone 2D with respect to the portable telephone 2A in a step S53.

The delivery confirmation process described above is continued, and a decision is made in a step S54 to determine whether further delivery confirmations need to be made. When the decision result in the step S54 is YES, the steps S49, S50, and S51 are executed. In other words, the step S49 deletes the delivery confirmed address of the destination from the delivery confirming folder 23, and the step S50 adds the delivery confirmed address of the destination to the sent folder 24. Hence, the destination information of the destinations to which the mail is delivered in a normal manner and confirmed by the delivery confirmation is moved from the delivery confirming folder 23 to the sent folder 24. In addition, the destination information of the destination (portable telephone D) to which the delivery is unsuccessful and the delivery abnormal is confirmed by the delivery confirmation remains in the delivery confirming folder 23.

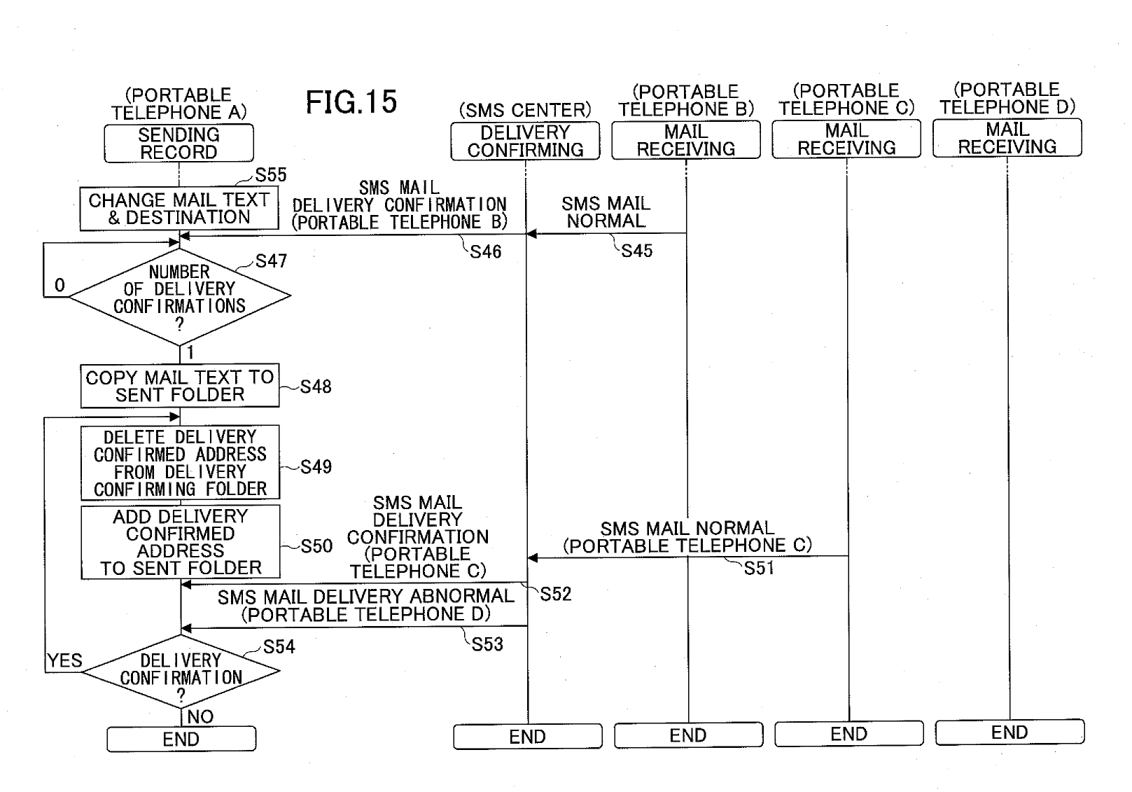

In this mail recording process, the mail text is deleted together with the destination information “portable telephone B”, “portable telephone C”, and “portable telephone D” from the unsent folder 22, when sending the mail in the steps S36, S37, and S38, respectively. At the same time as this deletion of the mail text and the destination information, the mail text is added together with the destination information “portable telephone B”, “portable telephone C”, and “portable telephone D” to the delivery confirming folder 23. Hence, with respect to such a process, a step S55 illustrated in FIG. 15 may be provided before the step S47 in order to move the mail text and the destination information from the unsent folder 22 to the delivery confirming folder 23. In this case, the other steps may be the same as those illustrated in FIGS. 13 and 14, and a description thereof will be omitted.

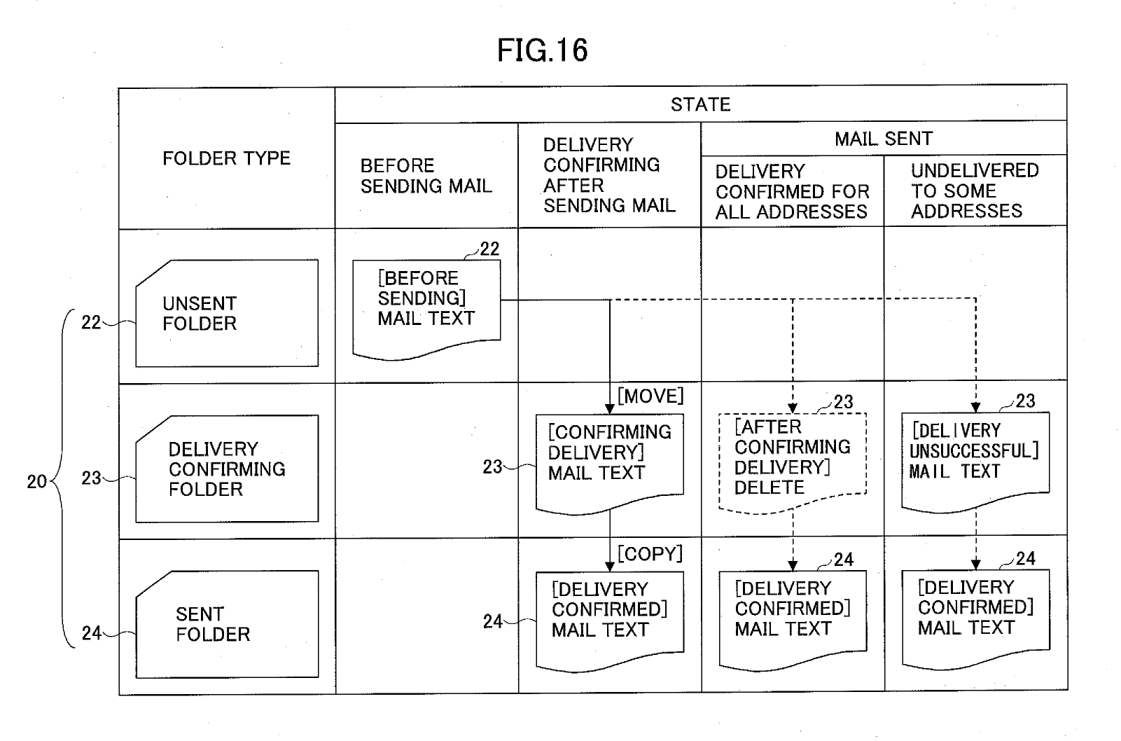

Next, a description will be given of a mail folder and data transition process (or function), by referring to FIG. 16. FIG. 16 is a diagram illustrating an example of processing contents of the mail recording process. Structures of the mail folder and data illustrated in FIG. 16 are merely examples, and the present invention is of course not limited to such structures.

In FIG. 16, the mail folder 20 includes the unsent folder 22, the delivery confirming folder 23, and the sent folder 24. The data transition of these folders 22, 23, and 24 includes states such as “before sending mail”, “delivery confirming after sending mail”, and “mail sent”.

As indicated by arrows in FIG. 16, the mail text stored in the unsent folder 22 in the “before sending mail” state is moved to the delivery confirming folder 23 after sending the mail and is copied to the sent folder 24 by delivery confirmation in the “delivery confirming after sending mail” state.

The “mail sent” state includes “delivery confirmed for all addresses”, and “undelivered to some addresses”. In the “delivery confirmed for all addresses” state, the destination for which the delivery is being confirmed becomes unnecessary when the delivery confirmation is completed with respect to all of the addresses, that is, all destinations, and thus, the stored contents of the delivery confirming folder 23 are deleted as indicated by a dotted line in FIG. 16. In addition, after the mail is sent, the mail text is copied from the delivery confirming folder 23 to the sent folder 24 by the delivery confirmation and the state in which the mail text is copied to the sent folder 24 is maintained.

On the other hand, in the “undelivered to some addresses” state, it is possible to recognize a state in which the delivery of the mail is unsuccessful with respect to some addresses, that is, some destinations, because the undelivered confirmation notification indicating the unsuccessful delivery is sent. Hence, the mail text whose delivery is unsuccessful remains in the delivery confirming folder 23 without being deleted, and although not illustrated in FIG. 16, the undelivered destination is also remains. After the mail is sent, the mail text is copied from the delivery confirming folder 23 to the sent folder 24 by the delivery confirmation and the state in which the mail text is copied to the sent folder 24 is maintained.

In the portable telephone 2, the sent mail recording function may be realized by adding the delivery confirming folder 23 with respect to the unsent folder 22 and the sent folder 24. In this case, the mail text in the unsent folder 22 is moved to the delivery confirming folder 23 after the mail is sent. When the first delivery is confirmed with respect to multicast mail, the mail text is copied to the sent folder 24. In this state, the mail text exists in both the delivery confirming folder 23 and the sent folder 24. Hence, when the delivery confirmation of the multicast mail ends in a normal manner with respect to all of the addresses, the mail text in the delivery confirming folder 23 is deleted. In addition, when the delivery confirmation of the multicast mail is not obtained with respect to some of the addresses, the mail text exists in both the delivery confirming folder 23 and the sent folder 24.

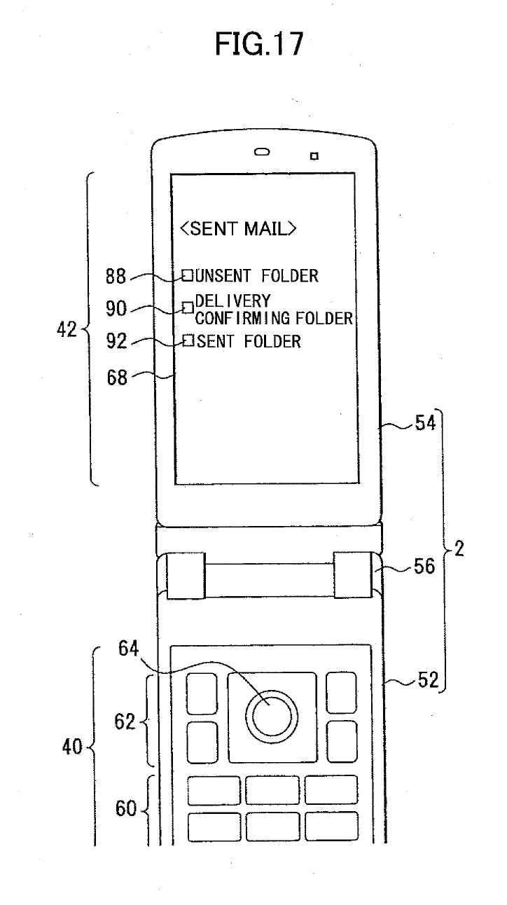

Next, a description will be given with respect to the display screen, by referring to FIG. 17. FIG. 17 is a diagram illustrating an example of the display screen of the portable telephone. A structure illustrated in FIG. 17 is merely an example, and the present invention is of course not limited to such a structure.

In the portable telephone 2, a function is selected from an initial screen. When “sent mail” function is selected from the initial screen, a title display “sent mail” is displayed on a display screen 68 of the display part 42 together with a unsent folder selection button 88, a delivery confirming folder selection button 90, and a sent folder selection button 92. When a cursor is moved to the unsent folder selection button 88, the delivery confirming folder selection button 90, or the sent folder selection button 92 and a submit button 64 is pushed, it is possible to select the unsent folder 22, the delivery confirming folder 23 or the sent folder 24.

When the unsent folder selection button 88 is selected, the recorded contents within the unsent folder 22 illustrated in FIG. 4 or FIG. 16 may be displayed on the display screen 68. In addition, when the delivery confirming folder selection button 90 is selected, the recorded contents within the delivery confirming folder 23 illustrated in FIG. 5 or FIG. 16 may be displayed on the display screen 68. Further, when the sent folder selection button 92 is selected, the recorded contents within the sent folder 24 illustrated in FIG. 6 or FIG. 16 may be displayed on the display screen 68. Hence, the recorded contents displayed on the display screen 68 may be reused when creating a mail and the like.

By adding the sent mail recording function to the portable telephone 2 of this second embodiment, the mail is recorded in the delivery confirming folder 23 until the delivery confirmation is completed when a plurality of destinations are specified for the mail. When the first delivery is confirmed and notified with respect to the multicast mail, the mail is copied from the delivery confirming folder 23 to the sent folder 24, and the mail is recorded in the sent folder 24. With respect to the destination for which the delivery confirmation is completed, the destination information is moved from the delivery confirming folder 24 to the sent folder 24. In other words, because only the destination information of the destination for which the delivery confirmation is completed is recorded in the sent folder 24, the mail may be edited and reused.

### Third Embodiment

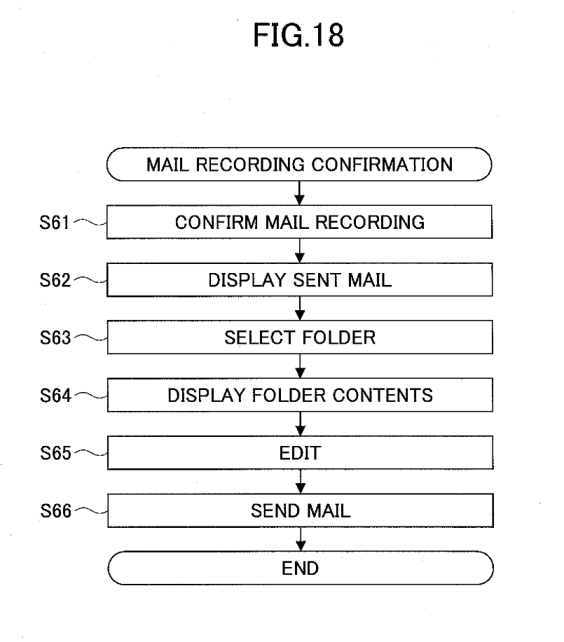

Next, a description will be given of a third embodiment, by referring to FIG. 18. FIG. 18 is a flow chart for explaining an example of procedures of a mail recording confirmation process in the third embodiment. The procedures of the process illustrated in FIG. 18 are merely examples, and the present invention is not limited to such procedures.

In this third embodiment, the portable telephone 2 may employ the functional parts illustrated in FIG. 8, the hardware structure illustrated in FIG. 9, and the external structure illustrated in FIG. 10.

After performing the procedures of the mail recording process described above in conjunction with FIGS. 13 through 15, a mail recording confirmation process may perform procedures illustrated in FIG. 18. The mail recording confirmation process (or function) is an example of the disclosed electronic equipment, mail recording method or the mail recording program.

In the mail recording confirmation process illustrated in FIG. 18, a mail recording is confirmed in a step S61 after the mail recording. When confirming the mail recording, the “sent mail” function may be selected from the initial screen in a step S62 in order to display the “sent mail” function on the display screen 68 as described above in conjunction with FIG. 17. A folder is selected from the displayed “sent mail” in a step S63, and the contents of the selected folder are displayed in a step S64.

As described above, the unsent mail, the sent mail, the delivery confirming mail, and the undelivered mail may be confirmed from the recorded contents of each of the folders 22, 23, and 24. The contents of the folders 22, 23, and 24 are displayed and the mail is edited in a step S65. A plurality of destinations of the mail are set, and the mail after being edited is sent as a multicast mail to the plurality of set destinations in a step S66.

### Comparison Example

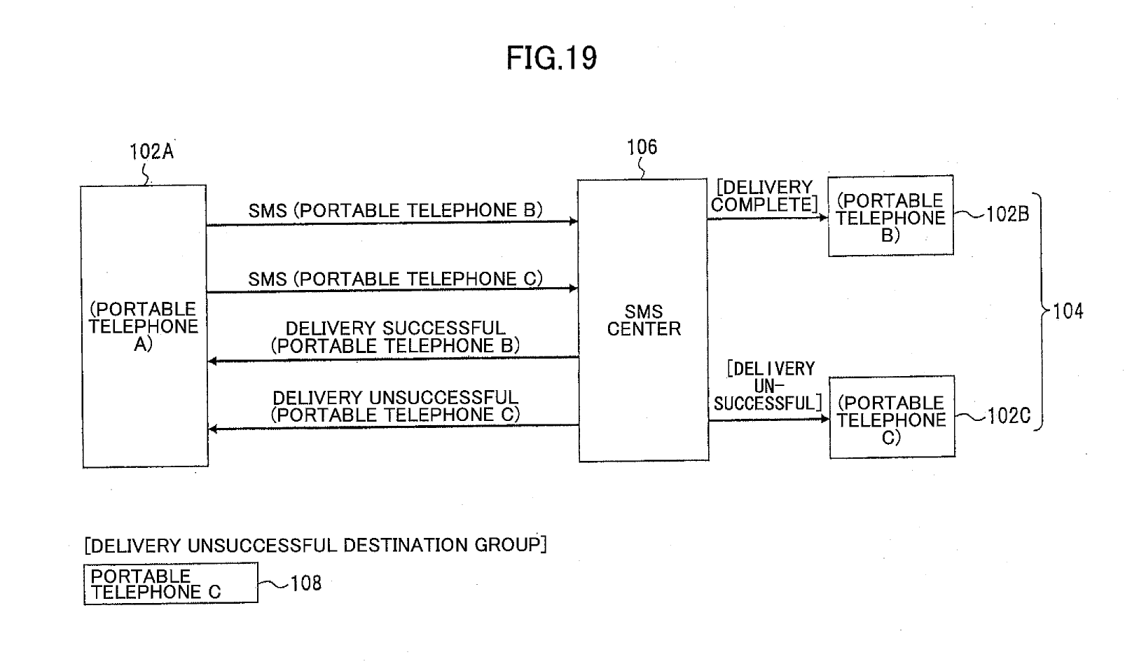

Next, a description will be given of a comparison example, by referring to FIG. 19. FIG. 19 is a block diagram for explaining a mail sending process of a portable telephone in the comparison example.

In this comparison example, it is assumed for the sake of convenience that a mail is sent from a portable telephone 102A with respect to a plurality of destinations 104, namely, portable telephones 102B and 102C. This comparison example performs a message communication, that is, a multicast transmission using a SMS center 106.

Further, in this comparison example, the SMS mail is sent from the portable telephone 102A to the portable telephones 102B and 102C, and the SMS mail delivery is completed with respect to the portable telephone 102B, while the SMS mail delivery is unsuccessful with respect to the portable telephone 102C. In this case, the successful SMS mail delivery to the portable telephone 102B may be recognized from delivery complete information included in a delivery confirmation notification received from the SMS center 106, and the unsuccessful SMS mail delivery to the portable telephone 102C may be recognized from undelivered information included in the delivery confirmation notification received from the SMS center 106.

The portable telephone 102A receives the delivery confirmation notification, and creates a destination list 108 related to the unsuccessful SMS mail delivery, and may manage the undelivered destinations in a delivery unsuccessful destination group. For example, the Japanese Laid-Open Patent Publication No. 2002-290619 proposes an example of a management system that registers the undelivered destinations or, destinations to which the delivery failed, in a failed group. When resenting the undelivered SMS mail, a destination of the failed group may be specified in order to facilitate the setting of the destination. However, when an undelivered destination is registered in the failed group, it is still necessary to perform a troublesome operation of specifying the failed group and resending the mail text.

On the other hand, according to the above described embodiments, the destination and the mail text of the mail whose delivery is being confirmed are recorded in the delivery confirming folder 23, and the mail text that is sent and the destination of the successful delivery are registered in the sent folder 24.

Hence, according to the above described embodiments, when the mail recording function is added to the portable telephone 2 and a plurality of destinations are specified for the multicast mail to be sent, the mail is recorded in the delivery confirming folder 23 until the mail delivery is confirmed. When the first delivery confirmation notification for the mail is received, this mail is copied from the delivery confirming folder 23 to the sent folder 24 and recorded in the sent folder 24. Only the destinations for which the mail delivery is confirmed are moved from the delivery confirming folder 23 to the sent folder 24, so that only the destinations for which the mail delivery is confirmed are recorded in the sent folder 24. Hence, the recorded mail may be edited and reused.

### Other Embodiments

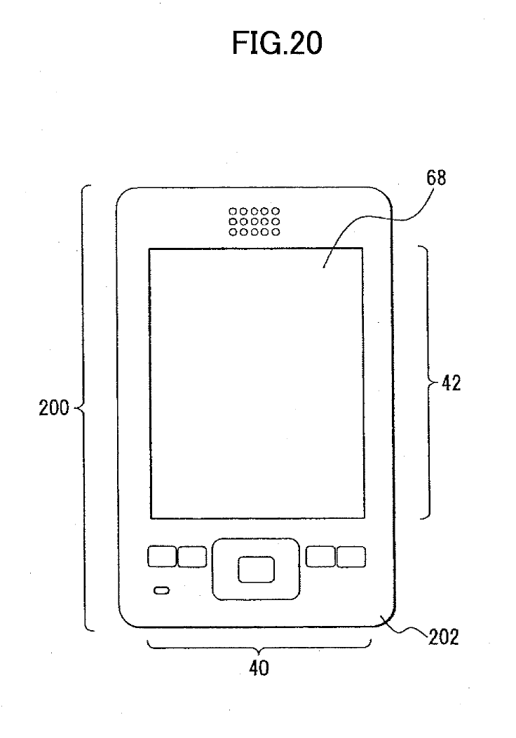

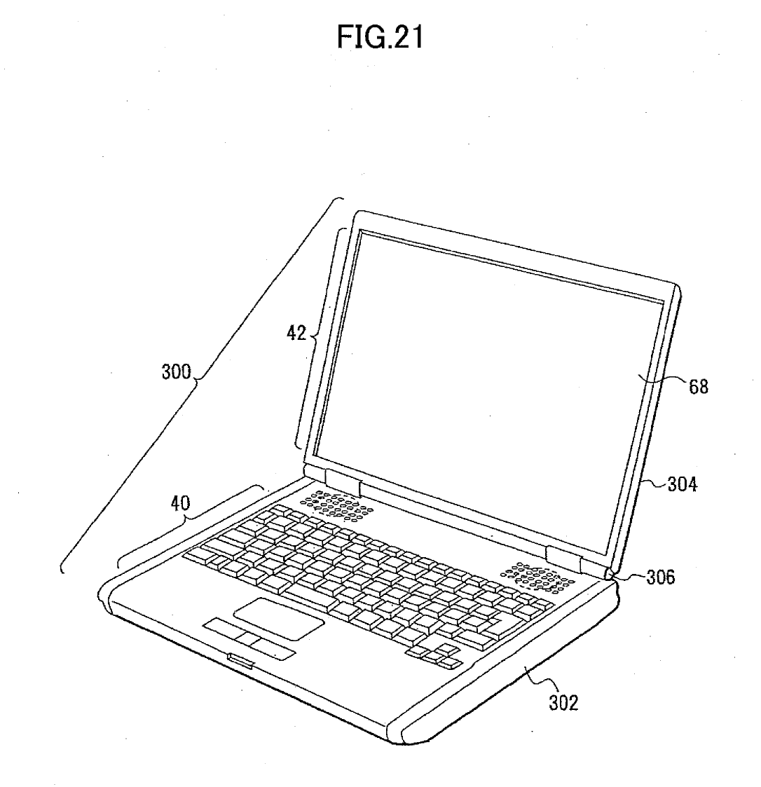

(1) The first embodiment provides examples of the electronic equipment, the mail recording method, the mail recording program, and the non-transitory computer-readable storage medium storing the mail recording program, while the second and third embodiments provide examples of the portable telephone, the mail recording method, the mail recording program, and the non-transitory computer-readable storage medium storing the mail recording program. However, the disclosed electronic equipment, mail recording method, mail recording program, and non-transitory computer-readable storage medium storing the mail recording program are not limited to those of the embodiments described above, and may be applied to any suitable electronic equipment having a communication function to communicate with a plurality of communicating destinations or a plurality of unspecified communicating destinations. For example, the electronic equipment may be formed by a PDA (Personal Digital Assistant) 200 illustrated in FIG. 20 having the communication function, a PC (Personal Computer) 300 illustrated in FIG. 21 having the communication function, and the like.

As illustrated in FIG. 20, the PDA 200 includes a display part 42, a display screen 68, and an input operation part 40 that are provided on a device body 202. Other parts and functions of the PDA 200 may be the same as those of the first through third embodiments described above.

As illustrated in FIG. 21, the PC 300 includes a fixed casing 302 and a movable casing 304 that are joined via a hinge part 306. The movable casing 304 may open and close with respect to the fixed casing 302 via the hinge part 306. An input operation part 40 is provided on the fixed casing 302, and a display part 42 and a display screen 68 are provided on the movable casing 304. Other parts and functions of the PC 300 may be the same as those of the first through third embodiments described above.

(2) The above described embodiments describe the message communication (for example, SMS) implemented in the portable telephone function. However, the disclosed electronic equipment, mail recording method, mail recording program, and non-transitory computer-readable storage medium storing the mail recording program are not limited to the message communication.

(3) In the above described embodiments, the mail text and the destination information are regarded as separate information, however, mail information may include both the mail text and the destination information. In addition, the mail information and a telephone directory may be linked in order to link address information of the telephone directory to the mail information. In this case, the address information in the delivery confirming folder 23 and the sent folder 24 may indicate information corresponding to the address in the telephone directory.

Although the embodiments are numbered with, for example, “first,” or “second,” or “third,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

1. An electronic equipment comprising:
a processor,
wherein the processor comprises:
a mail sending part configured to send a mail specifying a plurality of destinations;
a delivery confirming part configured to confirm delivery of the mail to the plurality of destinations based on a delivery confirmation notification received for the mail with respect to the plurality of destinations;
a delivery confirming recording part configured to record the mail sent by the mail sending part and whose delivery is being confirmed by the delivery confirming part together with each destination for which the delivery is being confirmed;
a delivery confirmed recording part configured to record the mail whose delivery is confirmed by the delivery confirming part together with each destination for which the delivery is confirmed; and
a recording control part configured to copy the mail from the delivery confirming recording part to the delivery confirmed recording part when the delivery confirmation notification is first received by the delivery confirming part, and move each destination for which the delivery confirmation notification is received from the delivery confirming recording part to the delivery confirmed recording part.

2. The electronic equipment as claimed in claim 1, wherein the delivery confirming part receives the delivery confirmation notification from a SMS (Short Message Service) center.

3. The electronic equipment as claimed in claim 1, wherein the processor further comprises:
a predelivery recording part configured to record the mail to be sent and each destination before the mail is sent,
wherein the recording control part moves the mail to be sent and each destination from the predelivery recording part to the delivery confirming recording part after the mail is sent.

4. A mail recording method to be implemented in an electronic equipment having a processor that is caused to perform a process comprising:
sending a mail specifying a plurality of destinations;
confirming delivery of the mail to the plurality of destinations based on a delivery confirmation notification received for the mail with respect to the plurality of destinations;
recording, in a delivery confirming recording part, the mail sent by the sending and whose delivery is being confirmed by the confirming together with each destination for which the delivery is being confirmed;
recording, in a delivery confirmed recording part, the mail whose delivery is confirmed by the confirming together with each destination for which the delivery is confirmed; and
controlling recording in order to copy the mail from the delivery confirming recording part to the delivery confirmed recording part when the delivery confirmation notification is first received by the confirming, and move each destination for which the delivery confirmation notification is received from the delivery confirming recording part to the delivery confirmed recording part.

5. The mail recording method as claimed in claim 4, wherein the confirming receives the delivery confirmation notification from a SMS (Short Message Service) center.

6. The electronic equipment as claimed in claim 4, further comprising:
recording, in a predelivery recording part, the mail to be sent and each destination before the mail is sent,
wherein the controlling recording moves the mail to be sent and each destination from the predelivery recording part to the delivery confirming recording part after the mail is sent.

7. A non-transitory computer-readable storage medium storing a program which, when executed by a computer, causes the computer to perform a process comprising:
a mail sending procedure to send a mail specifying a plurality of destinations;
a delivery confirming procedure to confirm delivery of the mail to the plurality of destinations based on a delivery confirmation notification received for the mail with respect to the plurality of destinations;
a delivery confirming procedure to record, in a delivery confirming recording part, the mail sent by the mail sending procedure and whose delivery is being confirmed by the delivery confirming procedure together with each destination for which the delivery is being confirmed;
a delivery confirmed recording procedure to record, in a delivery confirmed recording part, the mail whose delivery is confirmed by the delivery confirming procedure together with each destination for which the delivery is confirmed; and
a recording control procedure to copy the mail from the delivery confirming recording part to the delivery confirmed recording part when the delivery confirmation notification is first received by the delivery confirming procedure, and move each destination for which the delivery confirmation notification is received from the delivery confirming recording part to the delivery confirmed recording part.

8. The non-transitory computer-readable storage medium as claimed in claim 7, wherein the delivery confirming procedure receives the delivery confirmation notification from a SMS (Short Message Service) center.

9. The non-transitory computer-readable storage medium as claimed in claim 7, wherein the process further comprises:
a predelivery recording procedure to record, in a predelivery recording part, the mail to be sent and each destination before the mail is sent,
wherein the recording control procedure moves the mail to be sent and each destination from the predelivery recording part to the delivery confirming recording part after the mail is sent.
